(19) United States
(12) Patent Application Publication
(10) Pub. No.: US 2006/0075054 A1
(43) Pub. Date: Apr. 6, 2006

(54) Method and system for implementing instant communication of images through instant messaging tool

(75) Inventors: Qing Zhang, Shenzhen (CN); Lu Han, Shenzhen (CN)

Correspondence Address: HARNESS, DICKEY & PIERCE, P.L.C., P.O. BOX 828, BLOOMFIELD HILLS, MI, 48303, US

(73) Assignee: Tencent Technology (Shenzhen) Company Limited

(21) Appl. No.: 11/239,681

(22) Filed: Sep. 29, 2005

Related U.S. Application Data
(63) Continuation of application No. PCT/CN04/00844, filed on Jul. 21, 2004.

(30) Foreign Application Priority Data
Jul. 31, 2003 (CN) 03140011.6

(51) Int. Cl. G06F 15/16

(52) U.S. Cl. 709/206

(57) ABSTRACT

A method and a system thereof for implementing instant communication of images through instant messenger are provided in the present invention, image data processing module is added in the instant messenger, which is used to acquire image data and transit the acquired data into object data, then the object data are retransmitted to network side by instant messenger. The instant messenger inside receiving client extracts image data from the received information from the network side and displays contents of the information, namely displaying the image. By applying the present invention, instant communication and information interaction of images is implemented, practicability and interesting quality of instant messaging is further increased, new functions of instant messaging service are developed and value-added capability of instant messaging service is enhanced.

### CROSS-REFERENCE TO RELATED APPLICATIONS

This application is a continuation of International Application No. PCT/CN2004/000844 filed on Jul. 21, 2004. This application claims the benefit of Chinese Application No. 03140011.6 filed on Jul. 31, 2003. The disclosures of the above applications are incorporated herein by reference.

### FIELD OF THE INVENTION

The present invention relates to communication technique field, more particularly to a method and system for implementing instant communication of images through Instant Messaging Tool.

### BACKGROUND OF THE INVENTION

Network Instant Messaging (IM) service is a messaging service based on the Internet, mainly implementing network instant messaging function, and instant messaging tool is widely applied and approbated on the Internet. The user can perform operations like receiving and sending messages, and transmitting files.

When the user is applying an instant messaging tool, there are two methods for communication. One method is client-instant messaging server-client mode, namely the instant messaging tools in the clients communicate through an instant messaging server. The other method is client-client mode, namely instant messaging tools in the two clients communicate directly, without participation of instant messaging server. A communication method will be described in detail by taking the first communication mode for example.

FIG. 1 is a schematic diagram illustrating a structure of instant messaging system in the prior art. An instant messaging tool 2 is set inside client 3, and instant messaging tool 2 is composed of data store module 21, data analysis module 22, data transmission module 23, character input module 26 and data display module 24. The two clients 3 communicate instantly through instant messaging server 1 by applying instant messaging tools 2. Details of the method comprise:

Character input module 26 acquires character information, and transmits the acquired information to data store module 21 for storage. After that, data store module 21 in instant messaging tool 2 transmits the stored information to data display module 24 and data analysis module 22, data display module 24 displays character information for the terminal user, meanwhile, data analysis module 22 performs format transition and analysis process to the received data and transmits the data to data transmission module 23, then data transmission module 23 encapsulates the data information before transmitting the data to instant messaging server 1.

Instant messaging server 1 analyzes the received information, and then transmits the analyzed information to corresponding client. The instant messaging tool 2 that receives the analyzed information thereof transmits the received data to data analysis module 22 through data transmission module 23, data analysis module 22 analyzes the received data and extracts data information thereof before transmitting it to data store module 21 for storage, afterward, data store module 21 transmits the received information to data display module 24 to display the specific contents thereof, namely character information.

As for client-client communication mode, the implementation principle is the same as that of the above embodiment, wherein the difference only lies in that it is not needed for instant messaging server to retransmit the information between two clients, so this mode is not to be described hereinafter.

In an existing instant messaging system, no matter which communication mode is adopted, only instant communication and information interaction of character information can be implemented, while instant communication of images cannot be implemented.

### SUMMARY OF THE INVENTION

Therefore, the main object of the present invention is to provide a method and system for implementing instant communication of images through instant messaging tool, accordingly implementing instant communication and information interaction of images.

In the present invention, instant messenger represents the said instant messaging tool.

In order to obtain the above object, technical scheme of the present invention is implemented as follows:

A system for implementing instant communication of images through an instant messenger, comprising: a client of instant messenger, the said instant messenger comprising data store module, data analysis module and data transmission module, wherein the data transmission module transmitting the data that is from data store module and processed by data analysis module to network side, or data transmission module receiving data from network side and transmitting the received data to data analysis module to process, the processed data then being stored in data store module, wherein, the system thereof further comprising an image data processing module,

The said image data processing module being used to receive the user's commands, acquire image data, and transit the acquired data into object data before transmitting the object data thereof to data store module for storage.

Preferably, the said image data processing module being composed of image data acquisition module and image data transition module, wherein,

The said image data acquisition module receiving user's commands, acquiring image data and storing the acquired image data in the memory;

The said image data transition module obtaining the image data from the memory and transiting the image data into object data, and then transmitting the object data to data store module for storage.

Preferably, further comprising an instant messaging server, which receiving data from data transmission module inside the instant messenger at the client, transmitting the data thereof to network side, or the instant messaging server receiving data from network side, transmitting the data to data transmission module inside the instant messenger at the client.

A method for implementing instant communication of images by applying the above-mentioned system, comprising:

a. instant messenger inside transmitting client acquiring image data and storing the acquired data inside the memory, then transiting the image data thereof into object data;

b. instant messenger inside transmitting client reading in and storing the object data stream, displaying contents of the object data by itself; meanwhile, transmitting the object data stream to receiving client;

c. instant messenger inside transmitting client extracting object data from the received object data stream, and displaying contents of the object data by itself.

Preferably, the said instant messenger inside transmitting client in step a acquiring image data from system clipboard or image file or current screen image.

Preferably, when the said image data in step a is acquired from an image file, further comprising: the instant messenger uploading the image file first of all and then storing the acquired image data in the memory.

Preferably, when the said image data in step a is acquired from the current screen, further comprising:

a1. the instant messenger activating its own screen capture module, and storing current screen image data by cooperating with Windows desktop Device Context (DC);

a2. according to location and size of the selected image to be captured, storing the acquired image data in the memory.

Preferably, when there is a window supporting DirectX technique in the current screen, further comprising:

a11. the instant messenger visiting the memory directly, capturing and storing contents that are currently displayed in the window supporting DirectX technique;

a12. integrating the contents that are currently displayed in the window supporting DirectX technique and image data of current screen acquired in step a1, and storing the integrated data before executing step a2.

Preferably, the said image data being stored in the memory in bitmap format.

Preferably, the said object data stream in step b, which is read in and stored by the instant messenger inside transmitting client, comprising image data and character information.

Preferably, the said object data in step a being linkable.

Preferably, the method for transmitting client to transmit the object data stream to receiving client comprising:

Transmitting client directly transmitting the object data stream to receiving client, or transmitting client transmitting the object data stream to receiving client through an instant messaging server.

When applying the present invention, image data processing module is added in the instant messenger, thereby image data processing module acquires image data and transits the acquired data into object data, and then the instant messenger retransmits the object data thereof to network side. The instant messenger inside receiving client extracts image data from the received information from network side and displays the contents thereof, namely displaying the image. Instant communication and information interaction of images is implemented accordingly. By applying the present invention, practicability and interesting quality of instant messaging are increased, new functions of instant messaging service is developed, and value-added capability of instant messaging service is enhanced.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram illustrating a structure of instant messaging system in the prior art;

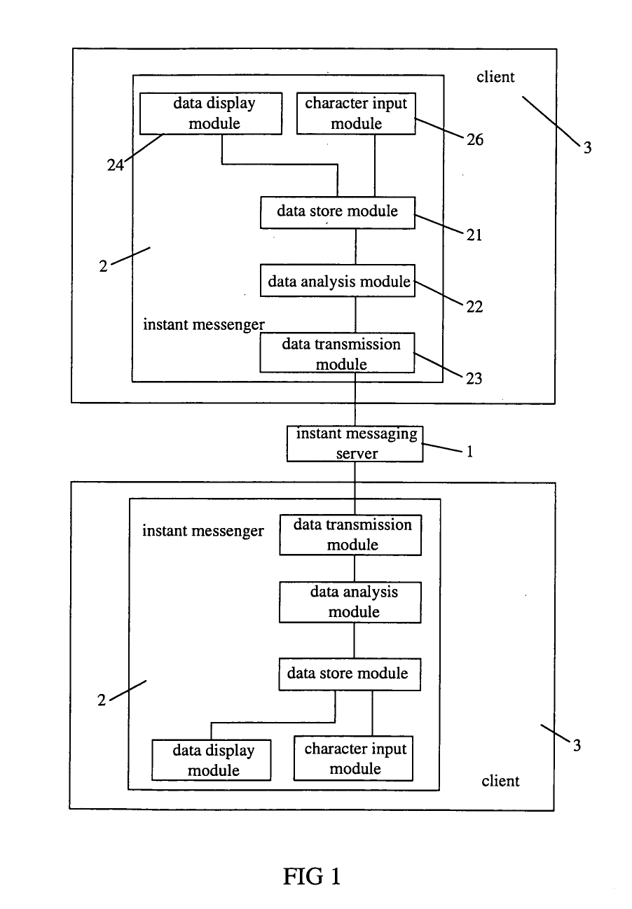

FIG. 2 is a schematic diagram illustrating an instant messaging system structure by applying one embodiment of the present invention;

FIG. 3 is a flowchart illustrating instant communication of images by applying the instant messenger in one embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention will be described in detail hereinafter with reference to the accompanying drawings.

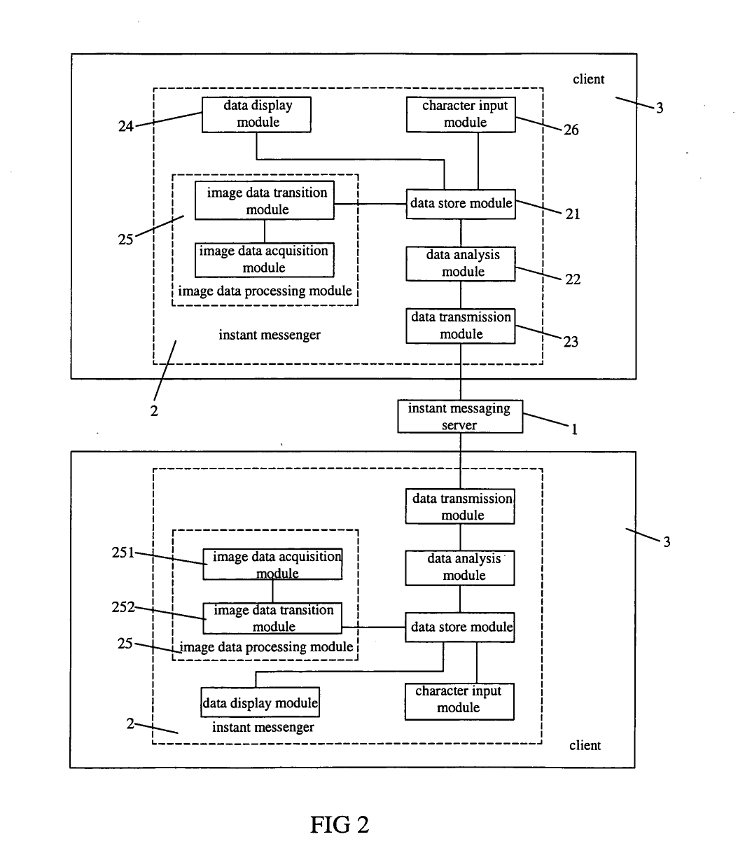

FIG. 2 is a schematic diagram illustrating an instant messaging system structure by applying one embodiment of the present invention. The said system of the present invention comprises instant messaging server 1 and client 3 comprising an instant messenger 2, and the said instant messenger 2 is composed of data store module 21, data analysis module 22, data transmission module 23, character input module 26 and data display module 24, wherein the said data analysis module 22 performs format transition and analysis process to the data stored in data store module 21 and that received by data transmission module 23, the said data transmission module 23 transmits the data, which are from data store module 21 and processed by data analysis module 22, to instant messaging server 1, instant messaging server 1 transmits the received data to network side, or, instant messaging server 1 receives data from network side and transmits the received data to data transmission module 23 inside instant messenger 2 in the client, after being processed by data analysis module 22, the data are stored in data store module 21, wherein, this system further comprises image data processing module 25, which is located inside instant messenger 2 and used for receiving the user's commands, acquisition image data and transiting the acquired data into object data before transmitting the object data to data store module 21 for storage.

The above-noted image data processing module 25 is composed of image data acquisition module 251 and image data transition module 252, wherein, image data acquisition module 251 receives user's commands, acquiring image data and storing the acquired image data in the memory; image data transition module 252 acquires image data from the memory and transits the data into object data before transmitting the object data to data store module 21 for storage.

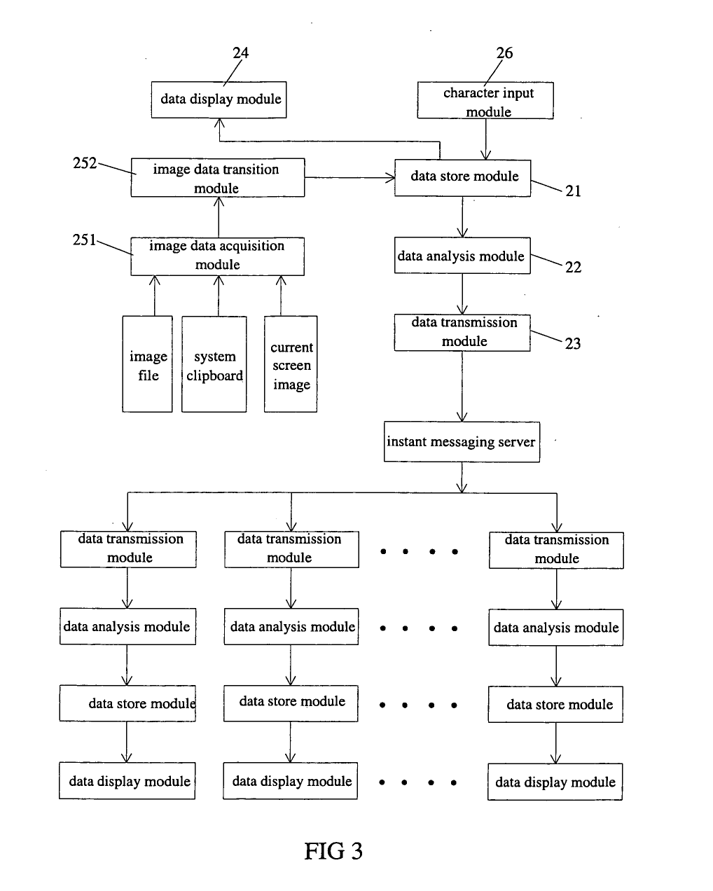

The method for implementing instant communication of images through instant messenger will be described in detail hereinafter, as shown in FIGS. 2 and 3, FIG. 3 is a flowchart illustrating instant communication of images by applying the instant messenger in one embodiment of the present invention.

Firstly, the instant messenger inside transmitting client acquires image data and stores the acquired image data in the memory, and then transmits the image data into object data. Specific procedure is:

According to the user's command, image data acquisition module 251 inside instant messenger at the transmitting client acquires the image data and stores the acquired data in the memory, then, image data transition module 252 obtains the image data from the memory and transits the data into object data before transmitting the object data to data store module 21 for storage. The object data thereof can be edited by image processing software; meanwhile, the object data are linkable which is linked to a certain image processing software, so that the user can perform secondary modification to the object data with the image processing software. In practical application, image data can be from multi sources, as shown in FIG. 3, the source can be image file or system clipboard or current screen image, etc.

When the object data are acquired from an image file, image data acquisition module 251 will upload this image file first of all and then store the acquired image data in the memory.

When the object data are acquired from the system clipboard, image data acquisition module 251 will directly store the acquired image data in the memory.

When the object data are acquired from current screen image, image data acquisition module 251 will activate the own screen capture module of instant messenger, and then stores the current screen image data by cooperating with Windows desktop Device Context (DC), according to location and size of the selected image to be captured, store the acquired image data in the memory. Windows desktop DC is a self function of Windows system, which defines a set of image operation objects, such as painting brush and pen, and maintains information of the defined image operation objects, so that the user can edit images by taking use of these image operation objects.

If there is a window supporting DirectX technique in the current screen, namely the generally called video window, before acquiring image data from the current screen image, image data acquisition module 251 will visit the memory directly at first, after capturing and storing the contents that are currently displayed in the window supporting DirectX technique, image data acquisition module 251 will integrate the contents that are currently displayed in the window supporting DirectX technique and the said image data of current screen acquired previously, and then store the acquired image data in the memory according to location and size of the selected image to be captured.

The above-noted image data are stored in the memory in bitmap format. In this way, image data from various sources are transited into object data by image data transition module 251.

Secondly, the instant messenger inside transmitting client reads in and stores the object data stream, displays contents of the object data by itself; meanwhile, transmits the object data stream to instant messaging server. Specific procedure is:

The object data stream, which is read in and stored by data store module 21 in the instant messenger inside transmitting client, comprises image data from image data processing module 25 and character information from character input module 26. With reference to FIG. 3, data store module 21 displays contents of the stored object data stream through data display module 24, the contents comprise image and character information. Meanwhile, data store module 21 transmits the self-stored object data stream to data analysis module 22.

After performing format transition and analysis process to the received data, data analysis module 22 transmits the processed data to data transmission module 23, and data transmission module 23 encapsulates the data information thereof before transmitting the data to instant messaging server 1. The encapsulated information comprises information like identifier and address of transmitting client and receiving client. Instant messaging server 1 analyzes the received message and transmits the message to one or more than one receiving clients according to the analyzed information.

At last, after receiving the object data stream from instant messaging server, the instant messenger inside receiving client extracts the object data thereof and displays contents of the object data by itself. With reference to FIG. 3, after data transmission module 23 in instant messenger 2 of each receiving client receives the information, information like object data and character information thereof is extracted by way of data analysis module 22, stored in data store module 21 and then displayed through data display module 24, namely related information like image and character is displayed. The specific procedure thereof is the same as that in the prior art and will not be described.

The above embodiment is described in detail by taking client-instant messaging server-client mode as example, as for client-client communication mode, the implementation principle thereof is the same as that of the above embodiment, wherein the difference lies in that instant messaging server is not needed to retransmit information between the clients, but the instant messengers in the clients communicate with each other directly, so this mode is not to be described hereinafter.

The description of the invention is merely exemplary in nature and, thus, variations that do not depart from the gist of the invention are intended to be within the scope of the invention. Such variations are not to be regarded as a departure from the spirit and scope of the invention.

1. A system for implementing instant communication of image information through an instant messaging tool, comprising: a client with instant messaging tool, the said instant messaging tool comprising data store module, data analysis module and data transmission module, wherein the data transmission module transmitting the data that is from data store module and processed by data analysis module to network side, or data transmission module receiving data from network side and transmitting the received data to data analysis module to process, the processed data then being stored in data store module, wherein, the system thereof further comprising an image data processing module,
the said image data processing module being used to receive the user's commands, acquire image data, and transit the acquired data into object data before transmitting the object data thereof to data store module for storage.

2. The system according to claim 1, wherein, the said image data processing module being composed of image data acquisition module and image data transition module, wherein,
the said image data acquisition module receiving user's commands, acquiring image data and storing the acquired image data in the memory;
the said image data transition module obtaining the image data from the memory and transiting the image data into object data, and then transmitting the object data to data store module for storage.

3. The system according to claim 1, wherein, further comprising an instant messaging server, which receiving data from data transmission module inside the instant messaging tool at the client, transmitting the data thereof to network side, or the instant messaging server receiving data from network side, transmitting the data to data transmission module inside the instant messaging tool at the client.

4. A method for implementing instant communication of images by applying the above-mentioned system, comprising:
a. instant messaging tool inside transmitting client acquiring image data and storing the acquired data inside the memory, then transiting the image data thereof into object data;
b. instant messaging tool inside transmitting client reading in and storing the object data stream, displaying contents of the object data by itself; meanwhile, transmitting the object data stream to receiving client;
c. instant messaging tool inside transmitting client extracting object data from the received object data stream, and displaying contents of the object data by itself.

5. The method according to claim 4, wherein, the said instant messaging tool inside transmitting client in step a acquiring image data from system clipboard or image file or current screen image.

6. The method according to claim 5, wherein, when the said image data in step a is acquired from an image file, further comprising: the instant messaging tool uploading the image file first of all and then storing the acquired image data in the memory.

7. The method according to claim 5, wherein, when the said image data in step a is acquired from the current screen, further comprising:
a1. the instant messaging tool activating its own screen capture module, and storing current screen image data by cooperating with Windows desktop Device Context (DC);
a2. according to location and size of the selected image to be captured, storing the acquired image data in the memory.

8. The method according to claim 7, wherein, when there is a window supporting DirectX technique in the current screen, further comprising:
a11. the instant messaging tool visiting the memory directly, capturing and storing contents that are currently displayed in the window supporting DirectX technique;
a12. integrating the contents that are currently displayed in the window supporting DirectX technique and image data of current screen acquired in step a1, and storing the integrated data before executing step a2.

9. The method according to claim 4, wherein, the said image data being stored in the memory in bitmap format.

10. The method according to claim 4, wherein, the said object data stream in step b, which is read in and stored by the instant messaging tool inside transmitting client, comprising image data and character information.

11. The method according to claim 4, wherein, the said object data in step a being linkable.

12. The method according to claim 4, wherein, the method for transmitting client to transmit the object data stream to receiving client comprising:
transmitting client directly transmitting the object data stream to receiving client, or transmitting client transmitting the object data stream to receiving client through an instant messaging server.

13. The method according to claim 5, wherein, the said image data being stored in the memory in bitmap format.

14. The method according to claim 6, wherein, the said image data being stored in the memory in bitmap format.

15. The method according to claim 7, wherein, the said image data being stored in the memory in bitmap format.
